(19) United States
(12) Patent Application Publication
(10) Pub. No.: US 2012/0213961 A1
(43) Pub. Date: Aug. 23, 2012

(54) MODULAR BUILDING SYSTEM

(76) Inventors: Robert Graham, Oklahoma City, OK (US); Jimmy D. Archer, Oklahoma City, OK (US)

(21) Appl. No.: 13/398,573

(22) Filed: Feb. 16, 2012

Related U.S. Application Data
(60) Provisional application No. 61/443,492, filed on Feb. 16, 2011.

(51) Int. Cl. B32B 3/06; B32B 3/10

(52) U.S. Cl. 428/43; 428/131; 428/99

(57) ABSTRACT

A modular construction member and kit including a panel having a first side and a second side opposite the first side and spaced apart from the first side by a distance defining a thickness. The panel having a plurality of ends extending between the first side and the second side with each of the first side, the second side, and at least one of the ends having a plurality of holes formed therein which are configured to receive a connector which is also receivable in a hole of a like panel for connecting the panel to the like panel.

### CROSS REFERENCE TO RELATED APPLICATIONS

The present application claims benefit of U.S. Provisional Application No. 61/443,492, filed Feb. 16, 2011, which is hereby incorporated herein by reference in its entirety.

### BACKGROUND

More homeowners and commercial property owners are turning their attention to structures that make outdoor living more enjoyable whether in new construction, remodeling or new additions. In addition, many homeowners enjoy remodeling and making additions to their homes more generally to meet their personal preferences and to express their own unique personalities and abilities. Some people prefer to hire professionals to do this work while many prefer to do such work themselves.

Among the many types of projects which may be undertaken by either homeowners or professionals are the design and building of structures such as planters, outdoor kitchens, outdoor furniture and living areas, retaining walls, and other structural building elements such as children's playhouses and storage facilities, as well as certain indoor structural elements. These structures may enhance the beauty and value of the property and provide additional living and workspace, as well as providing challenges and opportunities for personal expression. These projects are frequently custom-made using traditional building methods and products, such as lumber, welded aluminum angle, metal studs, or concrete blocks. In addition, there are an increasing number of homeowners who lack the time, tools, talent, or temperament necessary to tackle a custom made construction project and seek a more modular solution. In both custom and modular solutions, whether a project is being carried out by a homeowner or a professional, there is always a desire to lower costs, whether by reducing material costs and/or by reducing labor costs while maintaining or improving quality.

There have been many attempts in recent years to develop various modular or pre-manufactured construction systems geared toward both professional and the average “do-it-yourselfer.” In some instances, these products achieve satisfactory results, but in other instances may be difficult with which to work or fail to provide the “custom look” many property owners desire. These shortcomings are particularly evident in products developed for outdoor living or hardscapes.

### BRIEF DESCRIPTION OF THE DRAWINGS

FIG. 1 is a perspective view of an exemplary structure constructed using a modular building system in accordance with the inventive concepts disclosed herein.

FIG. 2 is a perspective view of a panel constructed in accordance with the inventive concepts disclosed herein.

FIG. 2A is a perspective view of another embodiment of a panel constructed in accordance with the inventive concepts disclosed herein.

FIG. 3 is a side elevational view of the panel of FIG. 2.

FIG. 4 is an end view of the panel of FIG. 2.

FIG. 5 is a cross-sectional view of a portion of two panels shown connected to one another with a connector in an end-to-side orientation.

FIG. 6 is a cross-sectional view of a portion of two panels shown connected to one another with a connector in an end-to-end orientation.

FIG. 7 is a perspective view of another embodiment of a panel constructed in accordance with the inventive concepts disclosed herein.

FIG. 8 is a sectional view of another embodiment of another structure constructed using the modular building system.

### DETAILED DESCRIPTION OF EXEMPLARY EMBODIMENTS

Before explaining at least one embodiment of the presently inventive concepts in detail, it is to be understood that the presently disclosed inventive concepts are not limited in its application to the details of construction, experiments, exemplary data, and/or the arrangement of the components set forth in the following description or illustrated in the drawings. The presently disclosed inventive concepts are capable of other embodiments or of being practiced or carried out in various ways. Also, it is to be understood that the phraseology and terminology employed herein is for purpose of description and should not be regarded as limiting.

Referring now to the FIG. 1, shown therein is a structure 10 which represents a type of structure that may be fabricated using a modular building system 12 in accordance with the presently disclosed inventive concepts. More specifically, the structure 10 is intended to represent a structure that may be used to form the framework of an outdoor kitchen that includes a cabinet for housing and supporting a grill and possibly a refrigerator, cabinets, or any number of uses. Other possible structures to be fabricated from the modular building system 12 include outdoor furniture, such as chair and benches, columns, site walls, planters, retaining walls, fences, interior walls, and combinations thereof.

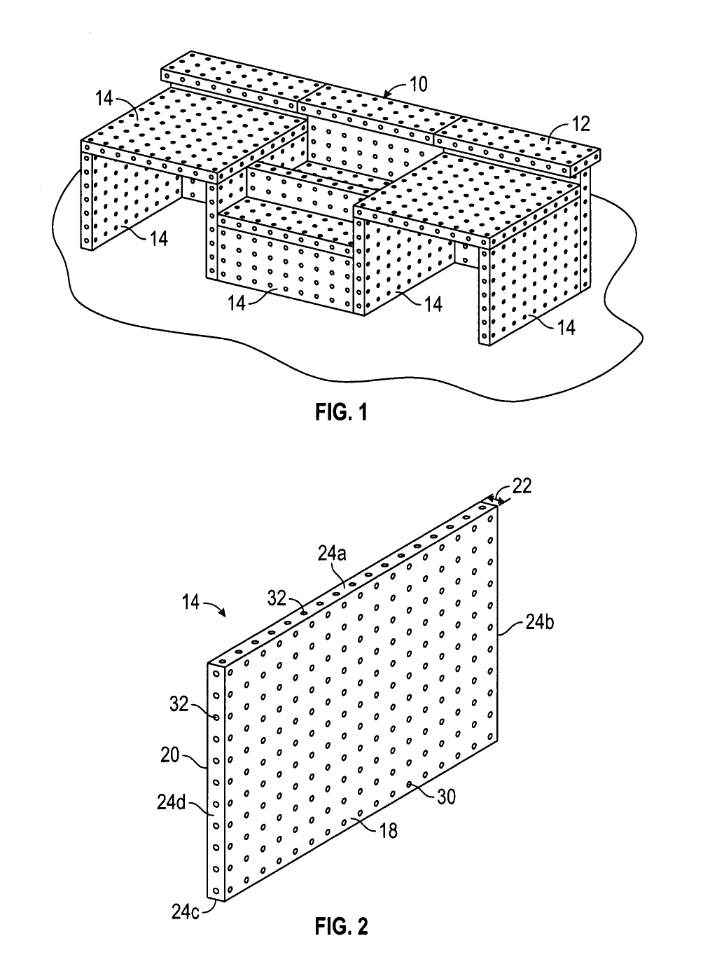

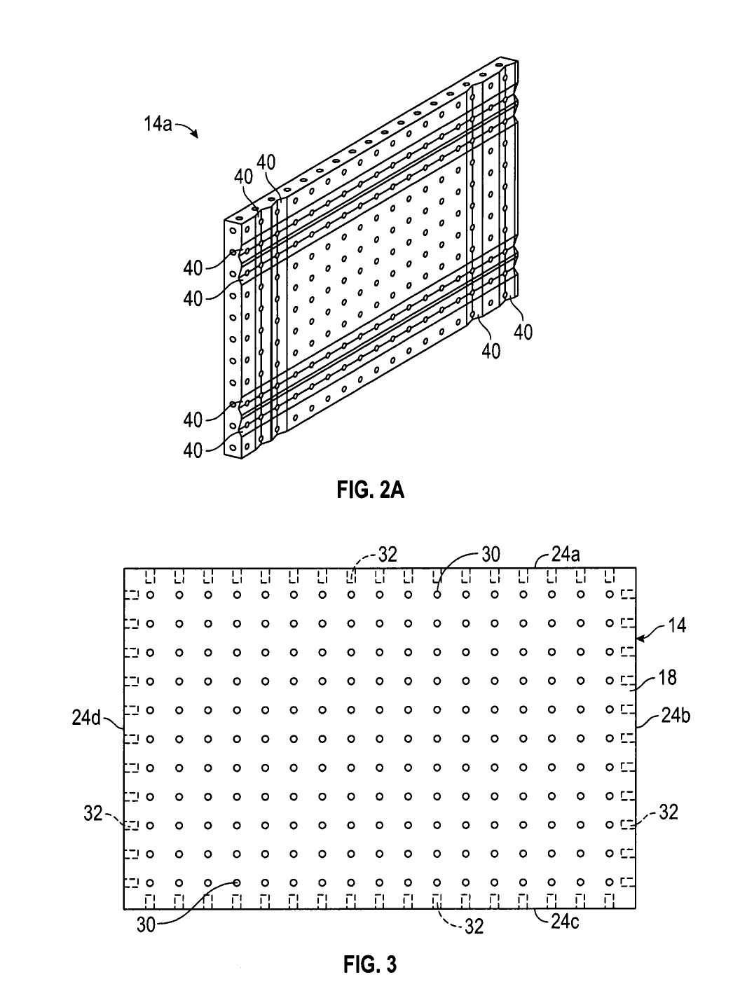

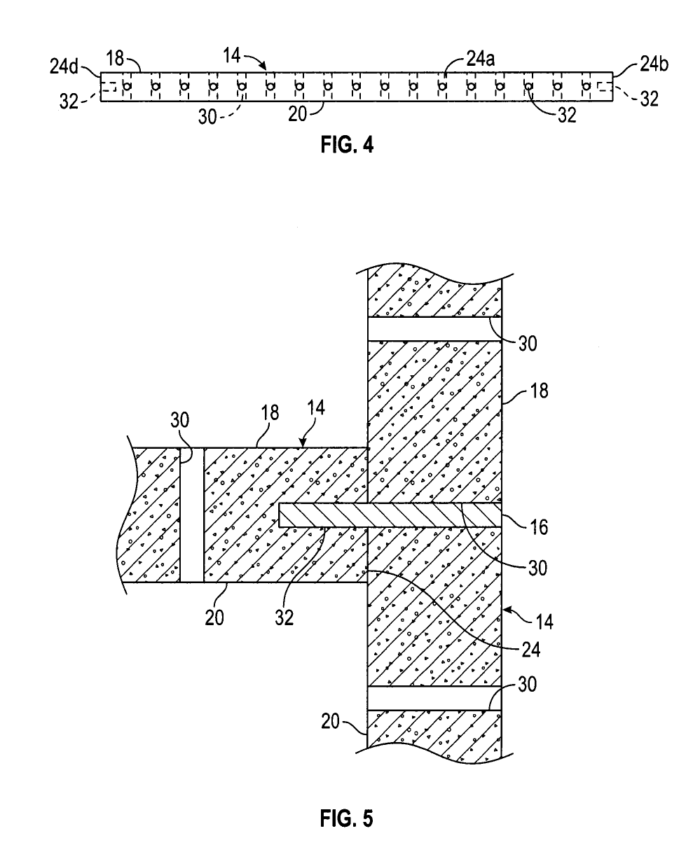

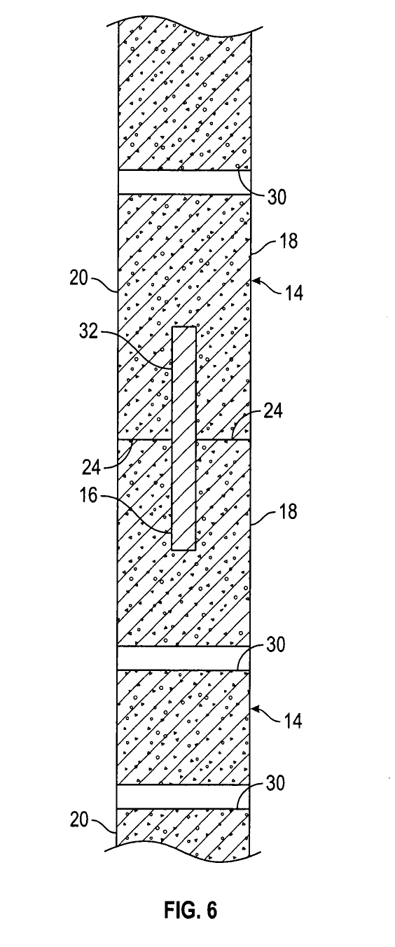

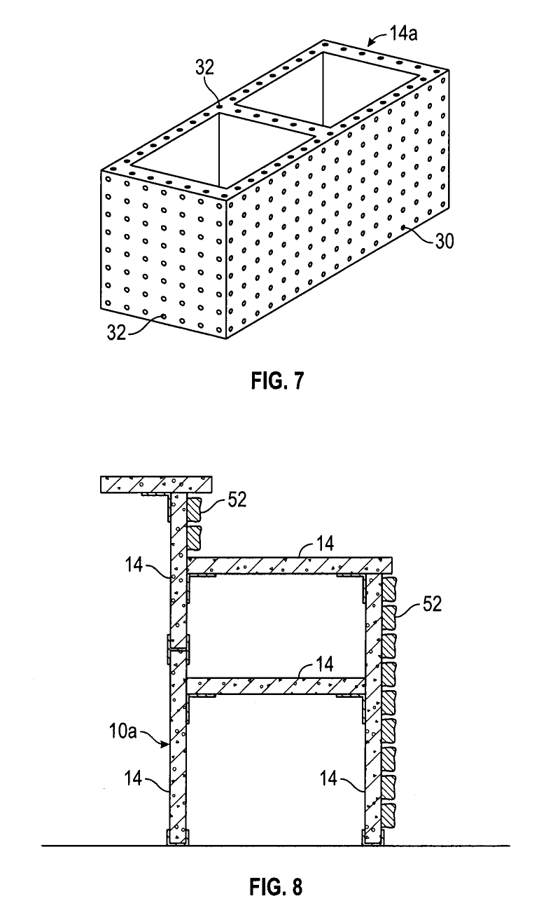

Referring now to FIGS. 2-6, the modular building system 12 broadly includes a plurality of panels 14 and a plurality of connectors 16 (FIGS. 5 and 6). The panels 14 and the connectors 16 are configured so that the panels 14 may be assembled in a fashion that might remind one of children's construction sets sold under the trademarks Tinkertoys® and Erector®. The panels 14 are shown to be generally flat and rectangular in shape so as to include a first side 18 and a second side 20 with the second side 20 spaced apart from the first side 18 a distance to define a thickness 22 of the panel 14. In addition, the panels 14 are shown to have a plurality of ends 24 (four peripheral ends 24a-24d are shown in FIG. 3). While the panels 14 are illustrated as being generally flat and rectangular, it is to be understood that the panels 14 can also be fabricated to have a variety of shapes, such as triangular, square, circular, octagonal, and star shaped, by way of example. By way of another example, a panel 14a is illustrated in FIG. 7. The panel 14a is in the form of a concrete block, known as a concrete masonry unit (“CMU”). The panel 14a may be provided with a plurality of holes 30 and 32 in a manner similar to that described and illustrated in relation to the panel 14.

The panels 14 may be produced in a manner to permit for more varied or custom configurations, such as assembling multiple panels or pieces of panels in a segmented arc or curved shape or assembling into angles greater or less than ninety degrees. In one aspect, the modular building system 12 may include a plurality of panels 14 wherein a portion of the panels 14 have one configuration (e.g., flat, block-like, curved, column shaped) and a portion of the panels 14 may have a different configuration (e.g., flat, block-like, curved, column shaped). In addition, the system 12 can be sold as a kit ready to be assembled on site into a known structure, e.g., an outdoor kitchen.

The panels 14 include a plurality of holes 30 extending through the panel 14 from the first side 18 to the second side 20. In this case, the holes on either of the first side 18 and the second side 20 are axially aligned. Alternatively, or in addition, the holes 30 may extend only partially through the panel 14. In this case, there could be holes only on one side, either the first side 18 or the second side 20. Each of the ends 24a-24d of the panels 14 is provided with a plurality of holes 32 which are shown to extend partially through the panel 14. In some embodiments, the holes 32 could penetrate from one end to another end. The holes 30 and 32 are spaced so that two or more holes of the first and second sides 18, 20 and/or the ends 24 are alignable with holes of one or more panels 14 to effect a connection between the two or more panels in a desired arrangement.

As illustrated in FIGS. 2-4, the holes 30 may be spaced evenly across the first side 18 and the second side 20 of the panel 14 in multiple rows and columns of holes. Such rows and columns may be intersecting and may be equally spaced. In addition to functioning as a means for connecting the panels in the modular system, the holes may function as register holes allowing the panels to be aligned readily on site with minimal effort, or the holes may facilitate the formation of larger openings of various sizes which may be formed in the panels 14 for receiving structures such as: appliances, cabinetry or related accessories, electrical conduit, electrical receptacles and switches, plumbing, and the like. Similarly, the holes 32 of the ends 24a-24d may be spaced evenly along the ends 24a-24d and aligned with the holes 30 of the first side 18 and the second side 20. It should be appreciated, however, that while the holes are shown as a single row, the number and spacing of the holes 30 and 32 may be varied depending on the size and thickness of the relevant manifestation.

The holes 30 and 32 are shown as being substantially rounded. However, it is to be understood that the holes 30 and 32 can be other shapes, as well. For example, the holes 30 and 32 can be square, triangular, rectangular, octagonal, as well as other geometrical and non-geometrical shapes. Additionally, the holes 30 and 32 can be formed where each of the holes 30 and 32 are the same size. Alternatively, the holes 30 and 32 can be of varying sizes.

The connectors 16 (FIG. 5) are configured to be inserted into the holes 30 and holes 32 to thereby interconnect two panels 14. More particularly, when two panels 14 are positioned adjacent to each other, such as illustrated in FIG. 5, the connectors 16 are inserted into the hole 30 or 32 of a first panel 14 and then the opposite end of the connector 16 is inserted into the hole 30 or 32 of the second panel 14 to thereby interconnect the panels 14. While FIG. 5 illustrates two panels 14 connected to one another in an end-to-side relationship, it will be understood that the arrangement of holes 30 and 32 in the first and second sides 18 and 20 and the ends 24a-24d provides the flexibility of connecting panels 14 with one another in other relationships, such as side-to-side and end-to-end (FIG. 6). Examples of suitable connectors 16 adapted to interconnect the panels 14 include, but are not limited to, dowels, such as pins, rods, screws, and nuts and bolt combinations. Further, the connectors 16 can also include one or more expandable members extending along their length where the members apply a force to the interior surface of the holes 30 and 32 when inserted therein to create a compression fitting. The connectors 16 and the holes 20 and 32 could also be used in conjunction with braces (e.g., expanded metal, angle) to permit other methods of attaching one panel to others.

As discussed above, the panels 14 are interconnected via connectors 16 to thereby form a structure, such as the structure 10. The size and shape of the holes 30 and 32 are sized to accept standard connectors appropriate for the use and dimension of the relevant embodiment of the panel (e.g., heavier or lighter weight, etc.). The size and shape of the holes 30 and 32 can be varied depending on the dimensions of the panels as well as the size and type of connectors 16 which are most likely to be desirable in the intended use. More particularly, the connectors 16 are sized and shaped so as to be adapted to be received by the holes 30 and 32 to thereby interconnect a plurality of the panels 14. For instance, if the holes 30 and 32 have a round shape and a ¼ inch diameter, then the connectors 16 are correspondingly sized and shaped (shape of the connectors may not correspond to holes for example, a star or x shape hole). Of course, the size and shape of the holes 30 and 32 can be modified to correspond to connectors of particular shape and size.

The panels 14 may be formed to have a variety of sizes and shapes and also be formed of a material having sufficient strength to support the structure 10 and any anticipated load. As discussed above, the structure 10 can be a wide variety of structures for use indoors or outdoors. As would be understood in the art, the size and shape of the structure 10 may determine the size, shape, arrangement of holes and material of the individual panels 14 used to form the structure 10. In one aspect, the panels 14 forming the structure 10 can be different sizes. These different size panels could be originally manufactured in such sizes or resized from a more standard size by the user in a manner consistent with their design (e.g., cutting or breaking along marked or scored lines). In another aspect, the panels 14 can each have the same size and shape wherein the user can determine the structure 10 to be formed. For example, the modular system 12 can be provided as a kit including a plurality of panels 14 and connectors 16. By way of example, the panels 14 may be 24 inches×36 inches×1.5 inches and include the holes 30 and the non-penetrating holes 32 formed therein. The user of the system 10 can then arrange and place the individual panels 14 in a shape, and interconnect the panels 14 via the connectors 16, so as to form the structure 10. Alternatively the modular system 12 could include panels 14 which come in multiple sizes and configurations to build a particular structure or structures without requiring any re-sizing if volume allows.

The panels 14 can be fabricated of a variety of materials. In exemplary embodiments, the panels 14 may be fabricated of traditional rigid, building materials that have sufficient strength and rigidity for supporting structural loads. In addition, the panels 14 can be fabricated from materials that are suitable for molding or casting, but the panels 14 can be fabricated of other materials if desired for a particular use. In other embodiments, the panels 14 could be manufactured by other methods or combinations of methods (e.g., mechanically by drilling holes). Examples of materials that may be used to form the panels 14 include, but are not limited to, concrete, and other cementitious materials, composite materials, plastic, metal, wood, ceramic, marble, rock, and the like. When formed using concrete, the concrete can be a traditional concrete, a lightweight concrete, and/or material such as an autoclaved aerated concrete. In one aspect, the material forming the panels 14 can be a fireproof or fire resistant material.

By way of example, the panel 14 may be formed to have the dimensions of 24 inches×36 inches×1.5 inches. The panel 14 may have a plurality of holes 30 formed on the first side 18 and extending through to the second side 20, i.e., penetrating holes 30. In this example, the holes 30 may be aligned in a linear fashion with the ends 24 of the first side 18, beginning two inches from the ends and repeating every two inches. Also in this example, the panel 14 may include the non-penetrating holes 32 formed on the ends 24 and extending into the panel 14. The first non-penetrating holes 32 are formed two inches from the edge and the non-penetrating holes 32 are repeated every two inches.

While the panels 14 have been described generally as having the holes 30 on, or through each of the first side 18 and the second side 20, it is to be understood that other configurations are also considered within the scope of the present disclosure. For instance, in one aspect, the panel 14 can include the plurality of non-penetrating holes 30 extending from the first side 18, or from the second side 20, and into a portion of the thickness 22 of the panel 14. Similarly, the panel 14 can be formed wherein only a portion of the ends 24 include the non-penetrating holes 32. For example, the ends 24a and 24b can include the non-penetrating holes 32. In another example, the ends 24b, 24c, and 24d can include the non-penetrating holes 32. As would be understood in the art, the non-penetrating holes 32 can be formed in any or none of the ends 24 depending on the cost of production and the intended use of the panel.

Referring now to FIG. 2A, another embodiment of a panel 14a is illustrated. The panel 14a is similar to the panel 14 described above, except the panel 14a is provided with one or more score lines 40 to permit the panel 14a to be more easily broken into smaller sizes. Methods of creating score lines are well known in the art and would vary depending on the material used to form the panel 14a. The score lines 40 permit the panels 14a to be broken on site into smaller pieces, which can then be interconnected with other unbroken panels 14 or 14a and with other broken panels 14a to permit the fabrication of customized structures. It will be appreciated that the score lines 40 may be formed in a variety of locations and patterns. For example, the score lines 40 may be formed along the panel 14a at selected locations on only one side of the panel to maintain the strength of the panel, such as illustrated in FIG. 2A, or score lines may be provided in a uniform pattern of equally spaced score lines. Also, the score lines may intersect the holes of the panel, or the score lines may extend between the rows and columns of the holes. In an alternative embodiment, the panel may not be scored at all, but marked with guide lines (not shown) on the sides and the ends to guide a user to form the panel to a desired shape and size.

In one embodiment, a mortar or adhesive compound may be used in conjunction with the connectors 16 to thereby provide additional connection strength as well as to seal the connection area between adjacent panels 14.

FIG. 8 illustrates a sectional view of another version of a structure 10a fabricated using the modular building system 12. FIG. 8 illustrates that a structure, such as the structure 10a, may serve as a substructure where additional facing material 52, e.g., bricks, stucco, and/or rock, can be attached to the outwardly facing portions of the panels 14 forming the structure 10a.

The holes 30 and 32 may allow connection of the panels 14 (or blocks or other shapes having the holes on each side) in vertical, horizontal, and diagonal planes. In addition, the panels 14 can be trimmed to allow a custom configuration. This use of holes 30 and 32 on all surfaces can be applied to any regular geometric shape that can be cast, molded, pierced or drilled.

An advantage of the system 12 is that standard, familiar, and intuitive construction methods in combination with standard commercial fasteners and hardware can be used to interconnect the panels 14. For example, other fasteners and hardware that can be used include, but are not limited to: all-thread with or without nuts and washers; bolts with nuts, washers, and fender washers; smooth pins; modified turnbuckle; plumber's tape; angle iron with hole(s) for anchor bolt; expanded metal plates and braces; bars to support custom horizontal and vertical panels (all-thread, smooth bar and rebar) cut for such things as shelves and recesses; standard woodworking hardware can be used to support such items as shelves and drawers; custom fasteners for custom panel configurations or temporary fasteners to stabilize the system prior to final assembly (e.g., before connectors are tight and in place); roll pin; nylon strapping with clips; electrical ties; anchors with screw or nail expander;

A number of custom or standard tools can be used in the assembly. For example, a masonry saw can be used to provide for custom shaping of the panel 14, manually, in the field. Or as another example, a jig (not shown) may be used for forming holes of the same diameter and spacing as the holes 30 and 32 in the newly exposed end of the panel 14 after the panel 14 is cut or broken along one of the score lines, as well for forming holes in a concrete foundation on which the structure is to be erected or, for example, a countertop to be attached to a structure, such as depicted in structure 10.

From the above description, it is clear that the inventive concepts disclosed herein are well adapted to carry out the objects and to attain the advantages mentioned herein, as well as those inherent in the invention. While presently preferred embodiments of the inventive concepts have been described for purposes of this disclosure, it will be understood that numerous changes may be made which will readily suggest themselves to those skilled in the art and which are accomplished within the spirit of the inventive concepts disclosed.

What is claimed is:

1. A modular construction member, comprising:
a panel having a first side and a second side opposite the first side and spaced apart from the first side by a distance defining a thickness, the panel having a plurality of ends extending between the first side and the second side, each of the first side, the second side, and at least one of the ends having a plurality of holes formed therein which are configured to receive a connector which is also receivable in a hole of a like panel for connecting the panel to the like panel.

2. The modular construction member of claim 1, wherein the holes of the first side and the second side are arranged in a plurality of intersecting rows and columns of holes.

3. The modular construction member of claim 2, wherein the holes of each of the rows and the columns of holes are equally spaced.

4. The modular construction member of claim 1, wherein the holes of the first side and the holes of the second side are axially aligned.

5. The modular construction member of claim 4, wherein the holes of the first side and the second side meet to form a plurality of through holes.

6. The modular construction member of claim 1, wherein the holes of the end are aligned with the holes of the first side and the second side.

7. The modular construction member of claim 1, wherein each of the ends has a plurality of holes formed therein which are configured to receive a connector which is also receivable in a hole of a like panel for connecting the panel to the like panel.

8. The modular construction member of claim 7, wherein the holes of the first side and the second side are arranged in a plurality of equally spaced, intersecting rows and columns of holes.

9. The modular construction member of claim 8, wherein the holes of the ends are aligned with one of the rows and the columns of holes of the first side and the second side.

10. The modular construction member of claim 7, wherein the holes of the first side and the holes of the second side are axially aligned.

11. The modular construction member of claim 10, wherein the holes of the first side and the second side meet to form a plurality of through holes.

12. The modular construction member of claim 7, wherein the holes of the ends are aligned with the holes of the first side and the second side.

13. The modular construction member of claim 1, wherein the panel has a plurality of score lines.

14. The modular construction member of claim 1, wherein the panel has a plurality of intersecting score lines.

15. A modular building kit, comprising:
a plurality of panels, each of the panels having a first side and a second side opposite the first side and spaced apart from the first side by a distance defining a thickness, each of the panels further having a plurality of ends extending between the first side and the second side, each of the first side, the second side, and at least one of the ends having a plurality of holes formed therein such that the holes are alignable with a plurality of the holes of another one of the panels; and
a plurality of connectors receivable in the holes of the panels in such a way as to connect two of the panels to one another.

16. The kit of claim 15, wherein the holes of the first side and the holes of the second side of each of the panels are arranged in a plurality of intersecting rows and columns of holes.

17. The kit of claim 16, wherein the holes of each of the rows and the columns of holes are equally spaced.

18. The kit of claim 15, wherein the holes of the first side and the holes of the second side are axially aligned.

19. The kit of claim 18, wherein the holes of the first side and the second side meet to form a plurality of through holes.

20. The kit of claim 15, wherein the holes of the end are aligned with the holes of the first side and the second side.

21. The kit of claim 15, wherein each of the ends has a plurality of holes formed therein which are configured to receive one of the connectors which is also receivable in one of the holes of another one of the panels.

22. The kit of claim 21, wherein the holes of the first side and the second side are arranged in a plurality of intersecting rows and columns of holes.

23. The kit of claim 22, wherein the holes of the ends are aligned with one of the rows and the columns of holes of the first side and the second side.

24. The kit of claim 21, wherein the holes of the first side and the holes of the second side of the panels are axially aligned.

25. The kit of claim 24, wherein the holes of the first side and the second side meet to form a plurality of through holes.

26. The kit of claim 21, wherein the holes of the ends are aligned with the holes of the first side and the second side.

27. The kit of claim 15, wherein at least one of the panels has a plurality of score lines.

28. The kit of claim 27, wherein the at least one panel has a plurality of intersecting score lines.

29. The kit of claim 15, wherein the connectors are dowels.

30. The kit of claim 15, further comprising a plurality of braces connectable to the panels.

31. A modular building kit, comprising:
a plurality of rigid panels, each of the panels having a first side and a second side opposite the first side and spaced apart from the first side by a distance defining a thickness, each of the panels further having a plurality of ends extending between the first side and the second side, the first side and the second side of each of the panels having a plurality of holes formed therein such that at least a portion of the holes of one of the panels is alignable with at least a portion of the plurality of holes of another one of the panels; and
means for connecting the panels to one another with at least a portion of the holes of one panel aligned with the holes of another one of the panels and in such a way as to form a composite load bearing structure.

32. The kit of claim 31, wherein the holes of the first side and the holes of the second side of each of the panels are arranged in a plurality of equally spaced, intersecting rows and columns of holes.

33. The kit of claim 32, wherein the holes of the first side and holes of the second side meet to form a plurality of through holes.

34. A modular building kit, comprising:
a plurality of rigid panels, each of the panels having a first side and a second side opposite the first side and spaced apart from the first side by a distance defining a thickness, each of the panels further having a plurality of ends extending between the first side and the second side, each of the panels having a plurality of holes formed therein, wherein the holes of at least one of the panels are arranged in a plurality of equally spaced, intersecting rows and columns of holes on at least one of the first side and the second side of the panel such that at least a portion of the holes of one of the panels is alignable with at least a portion of the plurality of holes of another one of the panels; and
means for connecting the panels to one another with at least a portion of the holes of one panel aligned with the holes of another one of the panels and in such a way as to form a composite load bearing structure.

35. The kit of claim 34, wherein at least one of the ends of each of the panels has a plurality of holes formed therein and wherein the holes of the at least one end are alignable with at least a portion of the plurality of holes of another one of the panels.

36. The kit of claim 35, wherein the holes of the at least one end are aligned with the holes of the rows and the columns of the holes.
